(19) United States
(12) Patent Application Publication
(10) Pub. No.: US 2011/0094316 A1
(43) Pub. Date: Apr. 28, 2011

(54) Torque-Indicating Extensive Apparatus

(76) Inventor: Wei-Ning HSIEH, Taiping City (TW)

(21) Appl. No.: 12/752,978

(22) Filed: Apr. 1, 2010

(30) Foreign Application Priority Data
Oct. 28, 2009 (TW) 098219892

(51) Int. Cl. G01L 3/02

(52) U.S. Cl. 73/862.321

(57) ABSTRACT

A torque-indicating extensive apparatus includes an extensive rod, two sensors and a display unit. The extensive rod includes a first engaging section for engagement with a handle, a second engaging section for engagement with a bit, a middle section extending between the first and second engaging sections, and a waist formed on the middle section. The size of the waist is larger than that of the second engagement section so that stress is not concentrated in the waist when torque is transmitted through the extensive rod. The sensors are attached to the waist. The display unit is electrically connected to the sensors.

### BACKGROUND OF INVENTION

1. Field of Invention

The present invention relates to a tool and, more particularly, to a torque-indicating extensive apparatus for a tool.

2. Related Prior Art

Torque tools such as open-ended wrenches, box-ended wrenches, socket wrenches, screwdrivers and Allen keys are used to tighten or slacken fasteners such as screws or nuts. A socket-wrench toolkit includes various sockets each for receiving a nut or an enlarged head of a screw of a specific size and a handle operable to rotate a selected one of the sockets.

However, it is difficult to use the socket wrench in a narrow and deep environment. In this case, an additional extensive element is used between the socket and the handle. Thus, a fastener in a narrow and deep environment can be reached with the socket and the socket can be rotated with the handle through the extensive element.

Sometimes, it is important to precisely exert a designed value of torque on a fastener because the fastener is used to join delicate parts together. In such a case, a torque gauge is used to measure and show a value of torque exerted on a fastener by a user. However, if the torque gauge is provided on the socket, various sockets need many torque gauges, and this is an expensive practice.

Referring to FIG. 5, an extensive element 90 is equipped with a torque gauge so that only one torque gauge is needed in a toolkit that includes a handle and various sockets in addition to the extensive element 90. The extensive element 90 includes a square insert 93 and a socket 94 with a square bore defined therein. The torque gauge includes two strain gauges 91 located on two planar faces 95 formed on a reduced section of the extensive rod 90 and a display 92 electrically connected to the strain gauges 91. The strain gauges 91 detect strain in the reduced section of the extensive rod 90 when a torque is transmitted through the extensive rod 90. On receiving a signal from the strain gauges 91, the display 92 shows the value of the torque.

The torque gauge however fails to provide exact values of torque. Moreover, the torque fails to provide a value of torque in a linear manner when the value exceeds a limit. After many tests, the problems have been found to be attributed to the size A of the reduced section of the extensive rod 90 being smaller than the size of the square insert 93 so that stress is concentrated in the reduced section of the extensive rod 90 when a value of torque exceeds the limit.

The present invention is therefore intended to obviate or at least alleviate the problems encountered in prior art.

### SUMMARY OF INVENTION

It is the primary objective of the present invention to provide a tool with a precise torque-indicating extensive apparatus.

To achieve the foregoing objective, the torque-indicating extensive apparatus includes an extensive rod, two sensors and a display unit. The extensive rod includes a first engaging section for engagement with a handle, a second engaging section for engagement with a bit, a middle section extending between the first and second engaging sections, and a waist formed on the middle section. The size of the waist is larger than that of the second engagement section so that stress is not concentrated in the waist when torque is transmitted through the extensive rod. The sensors are attached to the waist. The display unit is electrically connected to the sensors.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a tool with a torque-indicating extensive apparatus according to the first embodiment of the present invention;

FIG. 2 is an exploded view of the torque-indicating extensive apparatus shown in FIG. 1;

FIG. 3 is a cross-sectional view of the shown in FIG. 1;

FIG. 4 is a perspective view of a torque-indicating extensive apparatus according to the second embodiment of the present invention; and

FIG. 5 is a perspective view of a conventional torque-indicating extensive apparatus.

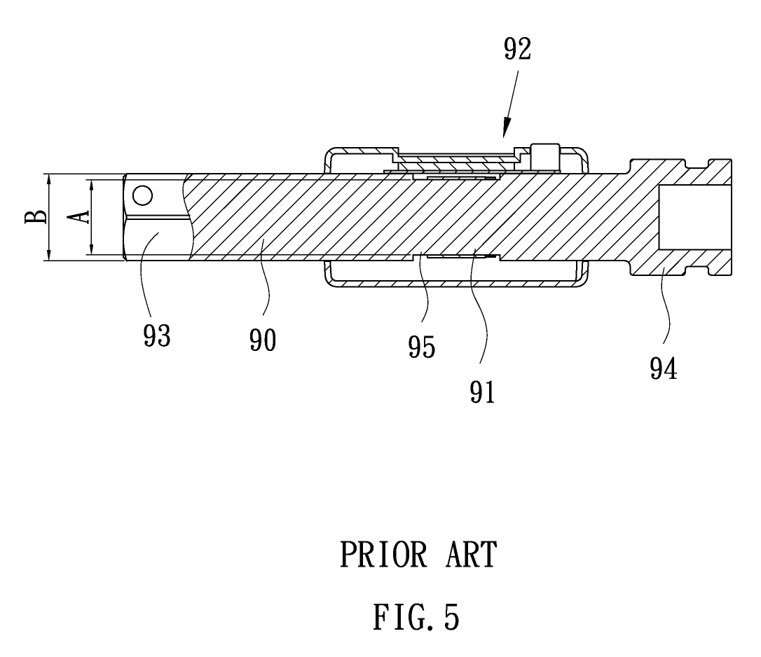

### DETAILED DESCRIPTION OF EMBODIMENTS

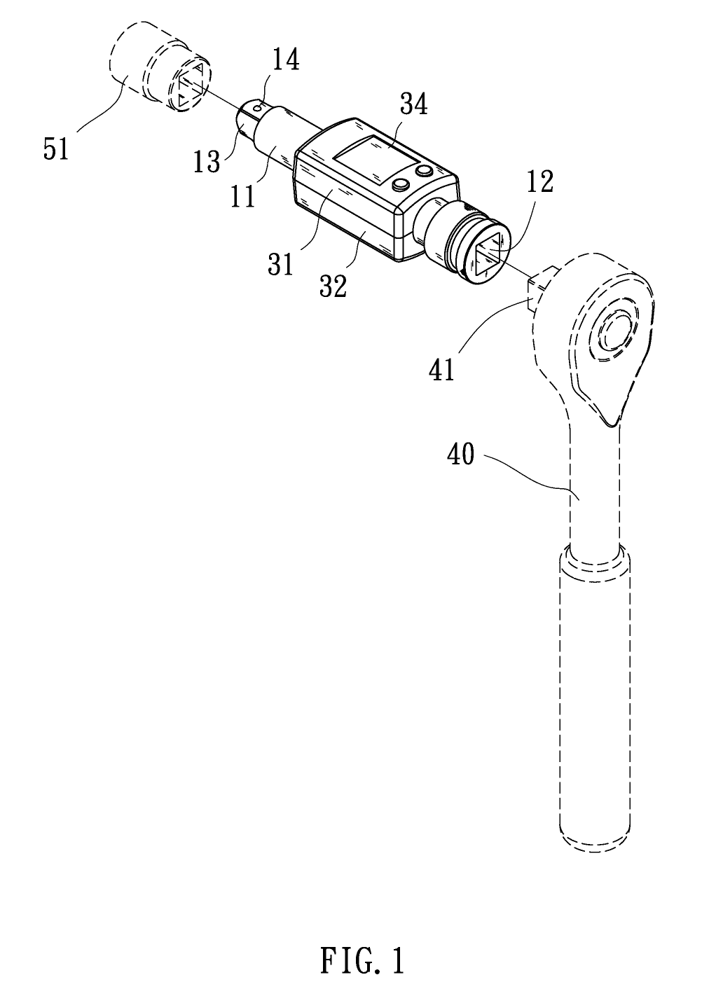

Referring to FIG. 1, a tool includes a handle 40, a socket 51 and a torque-indicating extensive apparatus according to a first embodiment of the present invention. The handle 40 includes a square axle 41. The handle 40 will not be further described in detail for being conventional. The socket 51 includes a square bore defined therein. The socket 51 will not be further described in detail for being conventional.

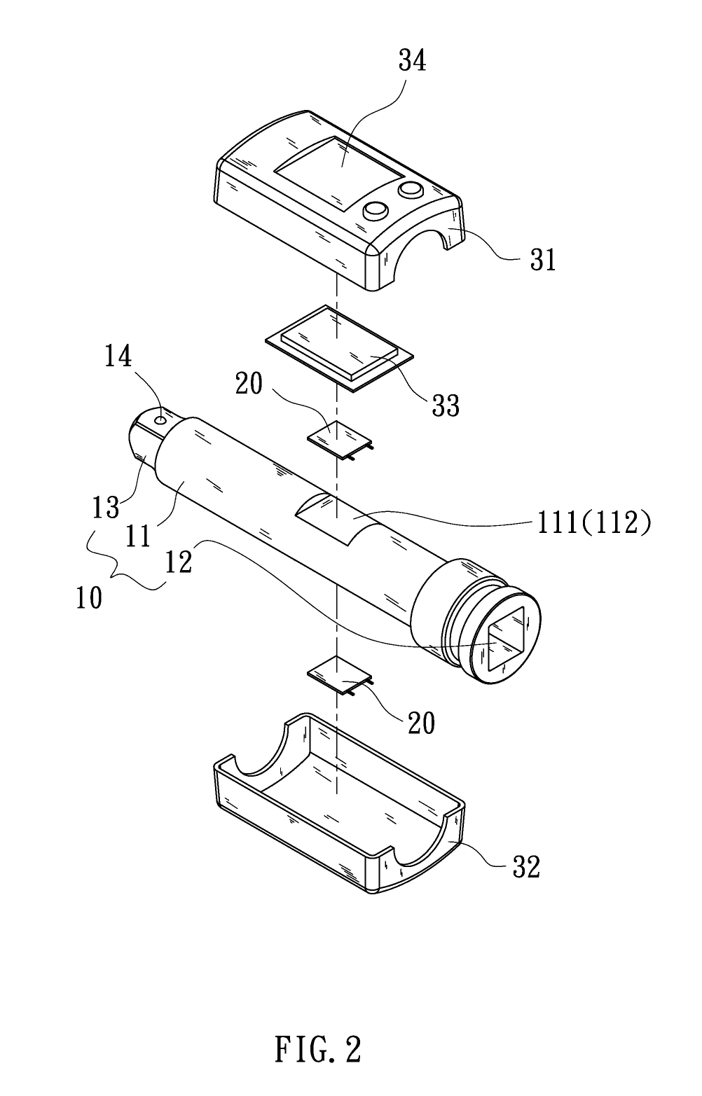

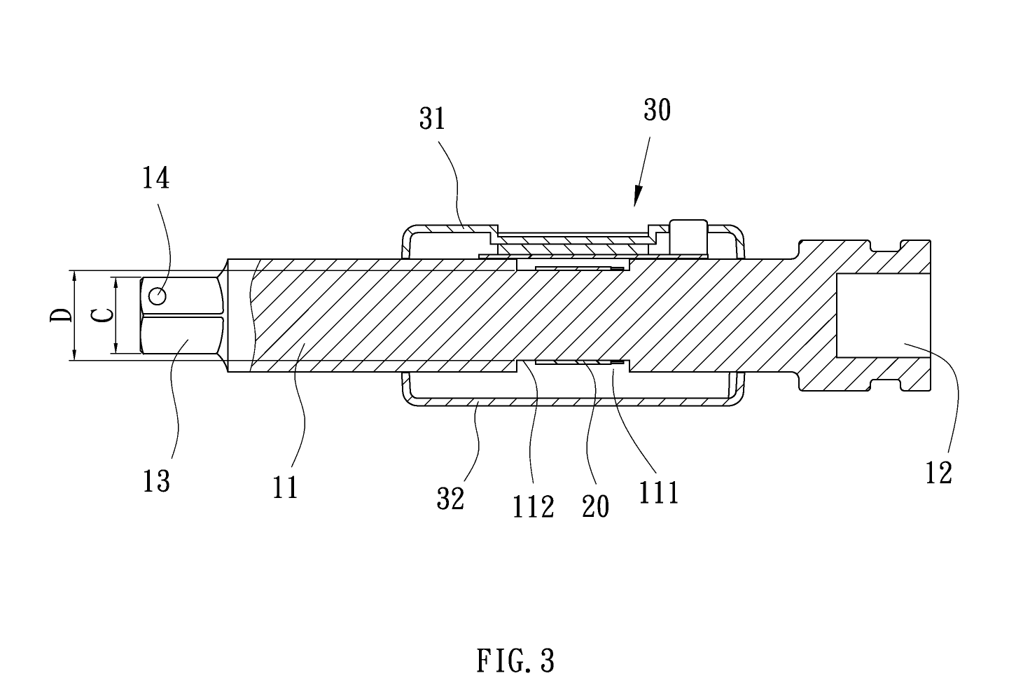

As shown in FIGS. 2 and 3, the torque-indicating extensive apparatus includes an extensive rod 10, two sensors 20, and a display unit 30. The extensive rod 10 includes a middle section 11 extending between a first engaging section 12 and a second engaging section 13. The middle section 11 of the extensive rod 10 includes a waist 111 formed with two opposite planar faces 112. The first engaging section 12 of the extensive rod 10 is a socket with a square bore for receiving the square axle 41 of the handle 40. The second engaging section 13 of the extensive rod 10 is a square insert for insertion in the square bore of the socket 51. A spring-biased detent 14 is provided on the second engaging section 13 of the extensive rod 10. The spring-biased detent 14 can retain the socket 51 on the second engaging section 13 of the extensive rod 10.

Each of the sensors 20 is located on and secured to a related one of the planar faces 112. The sensors 20 are preferably strain gauges. The sensors 20 will not be further described in detail for being conventional.

The display unit 30 includes a shell, a circuit board 33 and a display 34. The shell includes a front panel 31 joined with a rear panel 32. The circuit board 33 is electrically connected to the sensors 20 and located in the shell, i.e., between the panels 31 and 32. The display 34 is electrically connected to the circuit board 33 and located on the front panel 31. The display 34 is preferably a liquid crystal display. Buttons are located on the front panel 31 and electrically connected to the circuit board 33. Thus, the buttons are operable to control the display unit 30.

When torque is transmitted through the extensive rod 10, there is strain in the extensive rod 10. The sensors 20 detect strain in the waist 111 of the extensive rod 10, and send a signal to the circuit board 33. On receiving the signal, the circuit board 33 determines the torque based on the signal and instructs the display 34 to show the value of the torque.

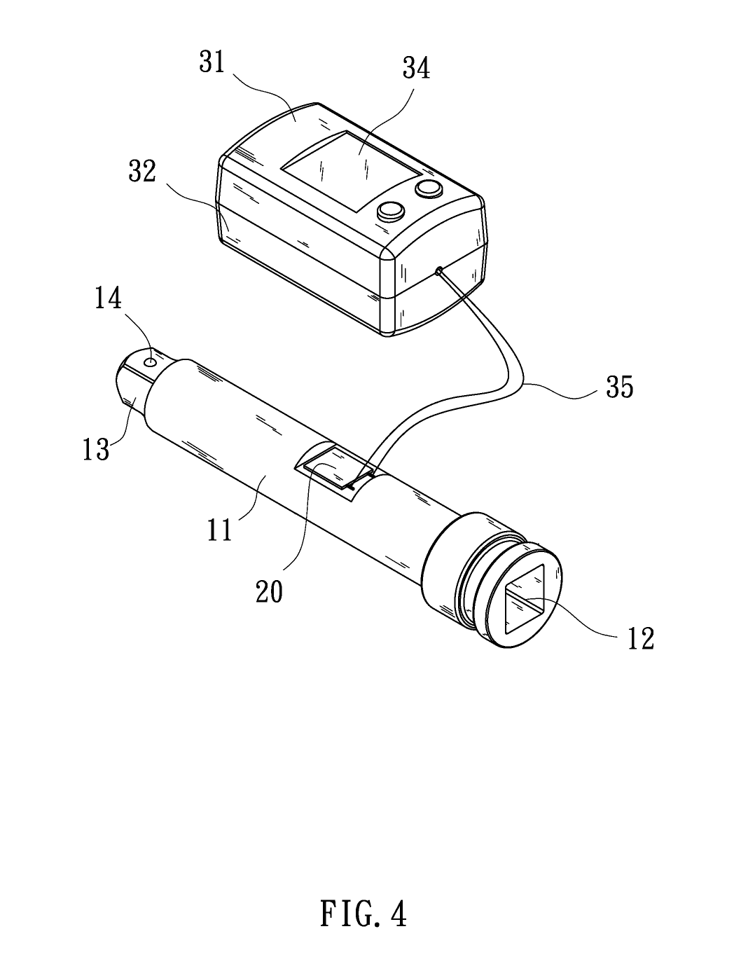

Referring to FIG. 4, there is shown a torque-indicating extensive apparatus according to a second embodiment of the present invention. The second embodiment is like the first embodiment except that the display unit 30 is not located on the extensive rod 10. The circuit board 33 is electrically connected to the sensors 20 through two wires 35 exposed to the exterior of the circuit board 33.

Advantageously, the size of the waist 111 is larger than the size of the square insert 13. In detail, the distance D between the planar faces 112 is larger than the distance C between two opposite planar facets of the square insert 13. Thus, stress would not be concentrated in the waist 111 during the transmission of the torque. Therefore, the value shown by the display unit 30 is precise. Furthermore, the sensors 20 and the display unit 30 together provide values of torque in a linear manner.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A torque-indicating extensive apparatus including:
an extensive rod including a first engaging section for engagement with a handle, a second engaging section for engagement with a bit, a middle section extending between the first and second engaging sections, and a waist formed on the middle section, wherein the size of the waist is larger than that of the second engagement section so that stress would not be concentrated in the waist when torque is transmitted through the extensive rod;
two sensors attached to the waist ; and
a display unit electrically connected to the sensors.

2. The torque-indicating extensive apparatus according to claim 1, wherein the extensive rod includes two opposite planar faces formed on the waist, wherein each of two sensors each attached to a related one of the opposite faces.

3. The torque-indicating extensive apparatus according to claim 2, wherein the distance between the opposite faces is larger than the distance between two opposite planar facets of the second engagement section of the extensive rod.

4. The torque-indicating extensive apparatus according to claim 1, wherein the display unit is located on the extensive rod.

5. The torque-indicating extensive apparatus according to claim 1, wherein the display unit is electrically connected to the sensors through wires exposed to the exterior of the display unit.
